(19) United States
(12) Patent Application Publication
(10) Pub. No.: US 2014/0369460 A1
(43) Pub. Date: Dec. 18, 2014

(54) METHOD AND APPARATUS FOR GENERATING X-RAYS IN COMPUTER TOMOGRAPHY SYSTEM

(71) Applicant: ELECTRONICS AND TELECOMMUNICATIONS RESEARCH INSTITUTE, Daejeon (KR)

(72) Inventors: Jin Woo JEONG, Daejeon (KR); Yoon-Ho SONG, Daejeon (KR); Sungyoul CHOI, Ulsan (KR); Jun Tae KANG, Daegu (KR); Jae-woo KIM, Daejeon (KR)

(73) Assignee: ELECTRONICS AND TELECOMMUNICATIONS RESEARCH INSTITUTE, Daejeon (KR)

(21) Appl. No.: 14/050,548

(22) Filed: Oct. 10, 2013

(30) Foreign Application Priority Data
Jun. 12, 2013 (KR) 10-2013-0067383

(51) Int. Cl. G21K 1/08; G01N 23/04

(52) U.S. Cl. CPC G21K 1/08; G01N 23/046
USPC 378/10

(57) ABSTRACT

A method and apparatus for generating X-rays that can acquire an X-ray image of a subject at a high speed are provided. When a CT system checks a subject, the CT system can acquire an X-ray image of the subject through rotating X-rays that are emitted from the X-ray generating apparatus and thus an

X-ray image of the subject can be obtained in various angles. Further, because it is unnecessary for the X-ray generating apparatus or the subject to move relative to each other, an X-ray image can be acquired at a high speed and thus a subject can be rapidly checked.

### CROSS-REFERENCE TO RELATED APPLICATION

This application claims priority to and the benefit of Korean Patent Application No. 10-2013-0067383 filed in the Korean Intellectual Property Office on Jun. 12, 2013, the entire contents of which are incorporated herein by reference.

### BACKGROUND OF THE INVENTION

(a) Field of the Invention

The present invention relates to a method and apparatus for generating X-rays in a computer tomography system.

(b) Description of the Related Art

A computer tomography (CT) system is technology that generates a tomogram by reconfiguring projection data within a human body that is obtained by a conventional X-ray photography technique with a computer.

In general, a CT system reconfigures several pictures that are acquired in various angles by a computer through relative movement between a rotating X-ray generator and a fixed subject or between a fixed X-ray generator and a rotating subject. Nowadays, a micro-defect within a circuit is searched for by applying a CT system of high magnification to a semiconductor circuit.

However, because a CT system with high magnification has a small field of view (FOV), an area that can be analyzed is limited, and many passes are required for analyzing and thus it is difficult to analyze many chips in real time in a semiconductor process line.

### SUMMARY OF THE INVENTION

The present invention has been made in an effort to provide a method and apparatus for generating X-rays having advantages of acquiring an X-ray image of a subject at a high speed in a CT system.

An exemplary embodiment of the present invention provides an X-ray generating apparatus of a CT system. The X-ray generating apparatus includes: an electron source that generates electron beams in a z-direction of a three-dimensional space; a beam deflecting unit that deflects the electron beams by a predetermined angle in the z-direction by transferring a force in an x-direction or a y-direction of the three-dimensional space to the electron beams; and a target unit that emits X-rays by colliding the electron beams.

The X-ray generating apparatus may further include a lens unit that focuses the deflected electron beams.

The target unit may emit X-rays that rotate on an xy-plane of the three-dimensional space about a z-axis of the three-dimensional space.

The electron source may be a negative electrode and the target unit may be a positive electrode.

Another embodiment of the present invention provides a method of generating X-rays of a CT system. The method includes: generating electron beams in a z-direction in a three-dimensional space; deflecting the electron beams by a predetermined angle in a z-direction by transferring a force in an x-direction or a y-direction to the electron beams; and emitting X-rays by colliding the electron beams with a target.

The method may further include focusing the deflected electron beams before the emitting of X-rays.

The emitting of X-rays may include emitting X-rays rotating on an xy-plane of the three-dimensional space about a z-axis of the three-dimensional space.

The electron beams may be generated in a negative electrode and the target may be a positive electrode.

Yet another embodiment of the present invention provides a CT system. The CT system includes: an X-ray generating apparatus that generates X-rays rotating on an xy-plane of a three-dimensional space about a z-axis of the three-dimensional space; a detection unit that detects formed X-ray images after the rotating X-rays are transmitted through a subject; and a controller that reconfigures a three-dimensional image by combining the detected X-ray images.

The detection unit may detect the X-ray images that are formed in a downward xy-plane of the subject after the X-rays that are emitted from the X-ray generating apparatus that is positioned above the subject are transmitted through the subject.

A distance from the X-ray generating apparatus to the subject may be smaller than that from the subject to the detection unit.

### BRIEF DESCRIPTION OF THE DRAWINGS

FIG. 1 is a diagram illustrating an X-ray generating apparatus according to an exemplary embodiment of the present invention.

FIG. 2 is a diagram illustrating a CT system according to an exemplary embodiment of the present invention.

FIGS. 3 and 4 are perspective views illustrating a CT system and a semiconductor wafer according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation, and can be implemented by hardware components or software components and combinations thereof.

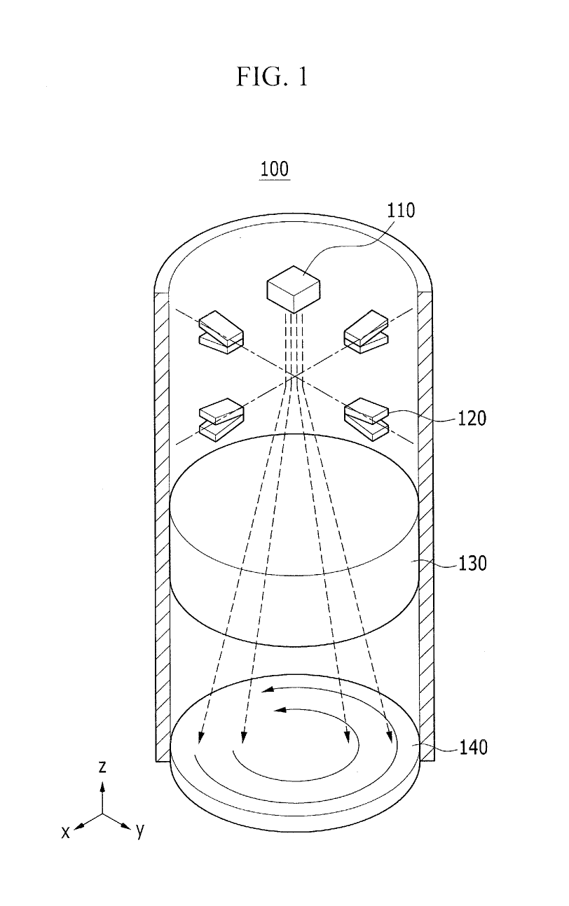

FIG. 1 is a diagram illustrating an X-ray generating apparatus according to an exemplary embodiment of the present invention.

Referring to FIG. 1, an X-ray generating apparatus 100 according to an exemplary embodiment of the present invention includes an electron source 110, a beam deflecting unit 120, a lens unit 130, and a target unit 140.

The electron source 110 generates electron beams and emits them in a z-direction of FIG. 1.

The beam deflecting unit 120 deflects electron beams that are emitted from the electron source 110. For example, by transferring a force of an x-direction and a y-direction to electron beams that are emitted in a z-direction, the beam deflecting unit 120 deflects the electron beams at a desired angle to a z-axis. That is, in a combination of a vector representing deflected electron beams, a starting point of each vector may be fixed to a vertex, and an ending point of each vector may represent a distributed cone shape along a circumferential edge of a base (circle).

Therefore, a deflected electron beam vector advances from a vertex of a cone toward a base of the cone using a z-axis as an axis of the cone, and an ending point of the deflected electron beam vector rotates about a z-axis according to a magnitude of a force of an x-direction and a y-direction that are transferred from the beam deflecting unit 120 and collides with a positive target that is positioned at an xy-plane.

The lens unit 130 focuses deflected electron beams through the beam deflecting unit 120.

The target unit 140 includes a positive target that enables electron beams that are focused at the lens unit 130 to emit X-rays.

According to an exemplary embodiment of the present invention, electron beams that are emitted in a z-direction from the electron source 110 are deflected in the beam deflecting unit 120, and after being focused in the lens unit 130, the electron beams collide with the positive target. In this case, the positive target is included in the target unit 140 that is formed in an xy-plane, and electron beams collide with the positive target while rotating about a z-axis and emit X-rays rotating in an xy-plane.

Hereinafter, a CT system will be described in detail using the X-ray generating apparatus 100 of FIG. 1.

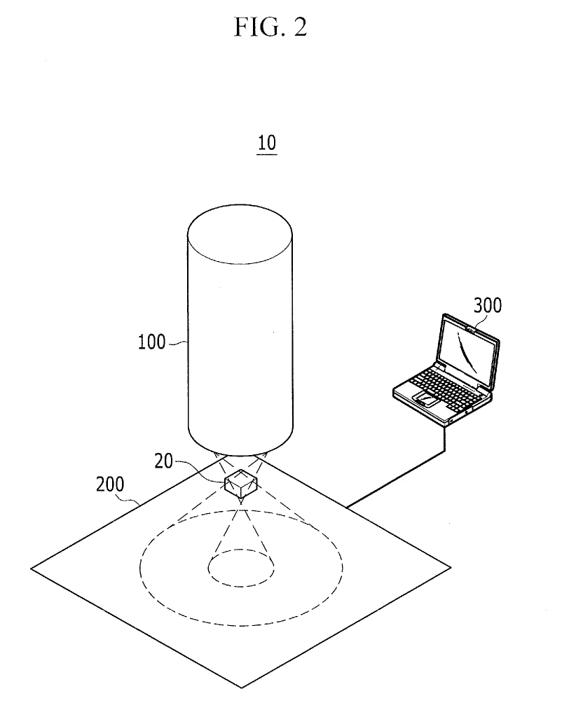

FIG. 2 is a diagram illustrating a CT system according to an exemplary embodiment of the present invention.

Referring to FIG. 2, a CT system 10 according to an exemplary embodiment of the present invention includes the X-ray generating apparatus 100, a detection unit 200, and a controller 300.

X-rays having been transmitted through a subject arrive at the detection unit 200, and X-rays having arrived at the detection unit 200 form an X-ray image of a subject 20. That is, the detection unit 200 is formed at an xy-plane, and X-rays that are emitted from the X-ray generating apparatus transmit through the subject 20 that is positioned on a z-axis and form an X-ray image of the subject 20 at an xy-plane below the subject 20.

According to an exemplary embodiment of the present invention, in order to photograph the subject 20 at various angles, in the X-ray generating apparatus 100, X-rays are emitted while rotating about a z-axis, and X-rays having been transmitted through the subject 20 at different angles form an X-ray image in the detection unit 200. In this case, a distance from the X-ray generating apparatus 100 to the subject 20 may be smaller than that from the subject 20 to the detection unit 200.

After X-rays transmit through the subject 20 at various angles, the controller 300 reconfigures a three-dimensional image by combining the formed X-ray images. That is, a user of the CT system 10 according to an exemplary embodiment of the present invention can find a defect of the subject 20 through a three-dimensional image that is reconfigured in the controller 300.

According to an exemplary embodiment of the present invention, even if the CT system 10 and the subject 20 do not relatively move, the X-ray generating apparatus 100 of the CT system 10 can emit X-rays by rotating and thus an X-ray image of the subject 20 can be obtained at a high speed.

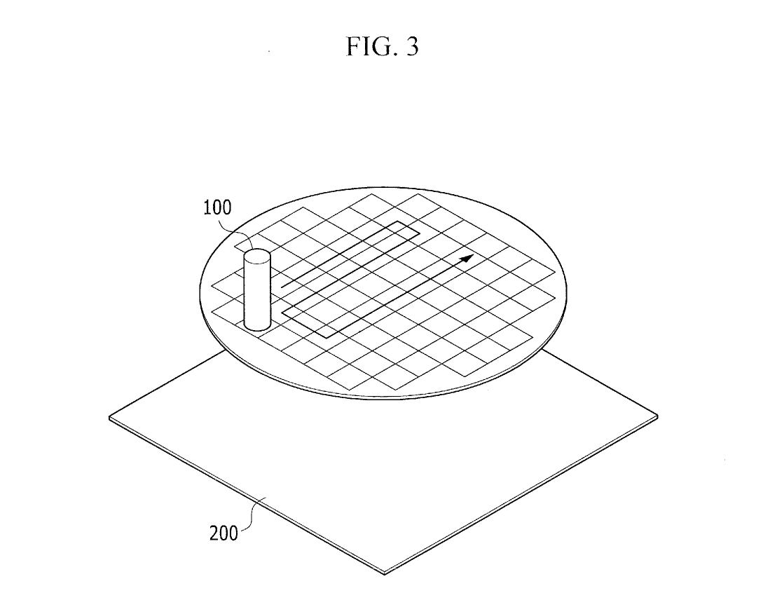

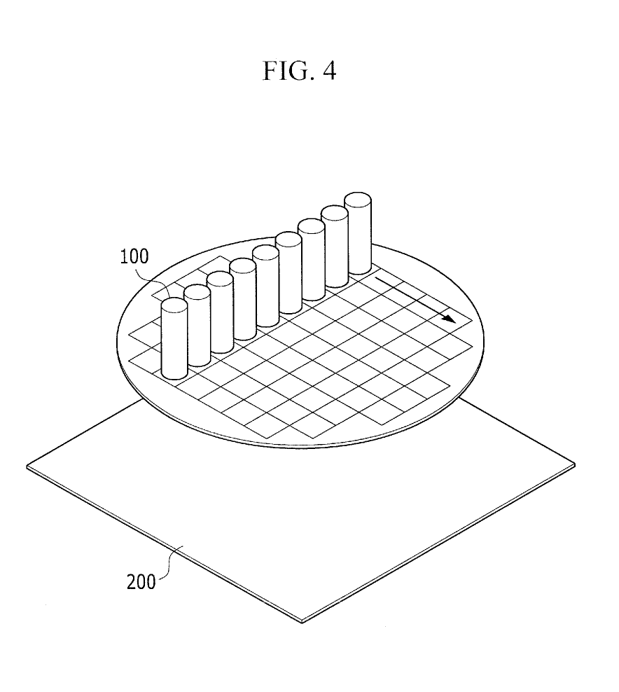

FIGS. 3 and 4 are perspective views illustrating a CT system and a semiconductor wafer according to an exemplary embodiment of the present invention.

Referring to FIG. 3, the CT system 10 checks each chip that is formed in a semiconductor wafer. That is, by positioning a semiconductor wafer between the X-ray generating apparatus 100 and the detection unit 200 of the CT system 10 and by relatively moving the CT system 10 and the semiconductor wafer, the CT system 10 checks chips.

Referring to FIG. 4, a plurality of CT systems 10 can check chips of one line that is formed in the semiconductor wafer at one time.

As described above, when the CT system 10 according to an exemplary embodiment of the present invention checks a subject, the CT system 10 can acquire an X-ray image of a subject through rotating X-rays that are emitted from the X-ray generating apparatus and thus an X-ray image of the subject can be obtained at various angles. Further, because it is unnecessary for the X-ray generating apparatus or the subject to move relative to each other, an X-ray image can be acquired in a high speed and thus the subject can be rapidly checked.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An X-ray generating apparatus of a computer tomography (CT) system, the X-ray generating apparatus comprising:
an electron source that generates electron beams in a z-direction of a three-dimensional space;
a beam deflecting unit that deflects the electron beams by a predetermined angle in the z-direction by transferring a force in an x-direction or a y-direction of the three-dimensional space to the electron beams; and
a target unit that emits X-rays by colliding with the electron beams.

2. The X-ray generating apparatus of claim 1, further comprising a lens unit that focuses the deflected electron beams.

3. The X-ray generating apparatus of claim 1, wherein the target unit emits X-rays that rotate on an xy-plane of the three-dimensional space about a z-axis of the three-dimensional space.

4. The X-ray generating apparatus of claim 1, wherein the electron source is a negative electrode and the target unit is a positive electrode.

5. A method of generating X-rays of a CT system, the method comprising:
generating electron beams in a z-direction in a three-dimensional space;
deflecting the electron beams by a predetermined angle in the z-direction by transferring a force in an x-direction or a y-direction to the electron beam; and
emitting X-rays by colliding the electron beams with a target.

6. The method of claim 5, further comprising focusing the deflected electron beams before the emitting of X-rays.

7. The method of claim 5, wherein the emitting of X-rays comprises emitting X-rays rotating on an xy-plane of the three-dimensional space about a z-axis of the three-dimensional space.

8. The method of claim 5, wherein the electron beams are generated in a negative electrode and the target is a positive electrode.

9. A CT system, comprising:
an X-ray generating apparatus that generates X-rays rotating on an xy-plane of a three-dimensional space about a z-axis of the three-dimensional space;
a detection unit that detects formed X-ray images after the rotating X-rays are transmitted through a subject; and
a controller that configures a three-dimensional image by combining the detected X-ray images.

10. The CT system of claim 9, wherein the detection unit detects the X-ray images that are formed in a downward xy-plane of the subject after the X-rays that are emitted from an X-ray generating apparatus that is positioned above the subject are transmitted through the subject.

11. The CT system of claim 10, wherein a distance from the X-ray generating apparatus to the subject is smaller than that from the subject to the detection unit.
